(19) United States
(12) Patent Application Publication
(10) Pub. No.: US 2014/0296626 A1
(43) Pub. Date: Oct. 2, 2014

(54) Textured Tongues

(71) Applicant: Zsavon Lovett Butler, Houston, TX (US)

(72) Inventor: Zsavon Lovett Butler, Houston, TX (US)

(21) Appl. No.: 13/852,160

(22) Filed: Mar. 28, 2013

(51) Int. Cl. A61H 19/00

(52) U.S. Cl. CPC A61H 19/30
USPC 600/38; 601/136

(57) ABSTRACT

The textured tongue sex stimulation device is used to enhance arousal to the bodies erogenous areas including but not limited to direct clitoral stimulation, vagina, penis, nipples, testicles, anus, and body. The sex stimulation device slides onto an individuals tongue like a sleeve and conforms. Imagine a condom for the tongue. The sex stimulation device is secured to tongue by a ribbed band and reinforcement strap. The tongue sex stimulation device has multiple textures and design variations used to elevate oral stimulation and help reach the ultimate climax. The sex stimulation device will consist of one continuous piece. All textures will be soft, and protrude from the surface of sex stimulation device. The cut and perforated version of sex stimulation device allow for additional tongue exposure while wearing the sex stimulation device. The sex stimulation device will be made out of a stretchy, thin and flexible material. Each version of the sex stimulation device will be available in various sizes to accommodate tongue sizes.

### FIELD OF THE INVENTION

The present invention relates to sex toys and more particularly to a sex toy including a textured tongue device.

### BACKGROUND

It is said, by medical experts, that internal orgasms experienced by women, as compared to clitoral orgasms, seem to be a much more intense form of orgasm. However these orgasms are also extremely difficult to achieve for most women. Many relationships and marriages fail due to sexual tension/frustration, so many forms of sexual therapy is prescribed. Direct clitoral stimulation seems to be the method of choice for marital orgasmic therapy.

Throughout history, individuals, especially women, have expressed how difficult it is to orgasm with their significant others through intercourse. And throughout history humans have sought sexual gratification by man made, assisted methods. Methods including but not limited to handheld devices such as vibrators and dildos etc. Some of these devices can be uncomfortable, numbing obtrusive and invasive.

The adult entertainment industry has flourished and the sex toy industry is always looking for new and exciting ideas for couples to experience various ways to please one another. There is still room in the marketplace for more direct, noninvasive and nonintrusive stimulating sex stimulation devices.

### SUMMARY

A tongue sex stimulation device for sexual arousal or therapy comprising:
a soft material housing such as latex, lambskin, silicone, elastomeric, and or flavored substance housing with various textures on surface, a ribbed band on all tops for snug fit and some bottoms of sex stimulation device for tongue exposure and secure grip, reinforced strap for optimal grip and comfort.
the sex stimulation device as described in claim 1, wherein the band comprises a reinforcement strap that is connected to the housing.
the sex stimulation device as described in claim 1, wherein the soft material housing slides onto the tongue with various textures to provide oral stimulation to erogenous zones.
A sex stimulation device as described in claim 1, wherein the sex stimulation device comes in multiple sizes to cater to tongue size variations.
the sex stimulation device as described in claim 1, where sex stimulation device consists of different elements but remains one solid unit making it easy to put on and remove if needed.

### BRIEF DESCRIPTION OF DRAWINGS

The invention may be understood by reference to the following description taken in conjunction with the accompanying drawings, in which, like reference numerals identify like elements, and in which:

FIG. 1 shows top view of tongue Instrument;

FIG. 2 shows bottom view of tongue Instrument;

FIG. 3 shows side view of tongue Instrument;

FIG. 4 shows top view of tongue Instrument with sample textures;

FIG. 5 shows back view of tongue Instrument with sample textures;

FIG. 6 shows side view of tongue Instrument with sample textures;

FIG. 7. shows top view of tongue Instrument with tip removed;

FIG. 8. shows bottom view of tongue Instrument with tip removed;

FIG. 9. shows side view of tongue Instrument with tip removed;

FIG. 10. shows the top view of Instrument with sample textures and tip removed;

FIG. 11. shows bottom view of Instrument with sample textures and tip removed;

FIG. 12. shows side view of Instrument with sample textures and tip removed;

FIG. 13. shows the top of the tongue Instrument with perforations;

FIG. 14. shows the top of the tongue Instrument with perforations and a sample texture;

FIG. 15. shows an overhead view of tongue Instruments' ribbed band and soft teeth;

FIG. 16. show a head on view of tongue Instrument with soft teeth;

FIG. 17. shows an overhead view of the ribbed band with soft mini nodules;

FIG. 18. shows an over head view of tongue Instruments' ribbed band, teeth and reinforcement strap;

### DETAILED DESCRIPTION

The textured tongue sex stimulation device is used to enhance arousal to the human bodies erogenous areas including but not limited to the vagina, penis, nipples and direct clitoral stimulation. The sex stimulation device slides onto a tongue of user like a sleeve in a sense a condom for the tongue. The sex stimulation device is secured to tongue by a reinforced ribbed band and strap. The tongue, sex stimulation device has multiple textures and design variations used to elevate oral stimulation. The sex stimulation device may be a one piece device, and textures may be soft, flexible and may protrude from the surface of the sex stimulation device. The sex stimulation device may include a cut portion and perforated portion to increase the tongue exposure of the user while wearing the sex stimulation device. For comfort, the sex stimulation device may be formed from a stretchy, ultra thin and/or highly flexible material.

The sex stimulation device may be unobtrusive to the user and may fit comfortably on the tongue of the user. The sex stimulation device may be used like an ornamented, condom for the tongue. In one embodiment, the substantially entire surface of the sex stimulation device may be covered with differing textures. Another embodiment exposes the tip of the tongue while the remaining portions of the sex stimulation device may be covered with textures. Another embodiment of the sex stimulation device includes perforations/apertures in a spaced relationship along the surface to allow the natural texture of the human tongue to come through the sex stimulation device along with the textures applied to surface of sex stimulation device.

The sex stimulation device may be fabricated in a variety of sizes, materials and style variations. Materials may include, but not limited to, latex variations, flavored Latex, Lambskin, Silicone, and a Sugar-Free Edible substance. The sex stimulation device may appear small when it comes out of pack, similar to a balloon. The sex stimulation device may be extremely flexible and expandable to allow user to slide the sex stimulation device on their tongue and to adjust the reinforcement strap if necessary to secure the sex stimulation device. The different textures and styles provide a variation of choices for the men or women giving or receiving the oral stimulation. The sex stimulation device invention is a sexual aid sex stimulation device used to elevate oral clitoral stimulation and the overall sexual experience.

Advantages of the invention are:
To provide a sleek, unobtrusive, non threatening sexual aid which may be positioned onto the tongue with minimal interference with normal movement of tongue.
To provide a sexual aid that can be both used and enjoyed by men and women.
To provide a stimulator that is self controlled by the natural movements and rhythm of the tongue.
To provide a sexual aid that enhance ones own abilities.

The following description is demonstrative in nature and is not intended to limit the scope of the invention or it application of uses.

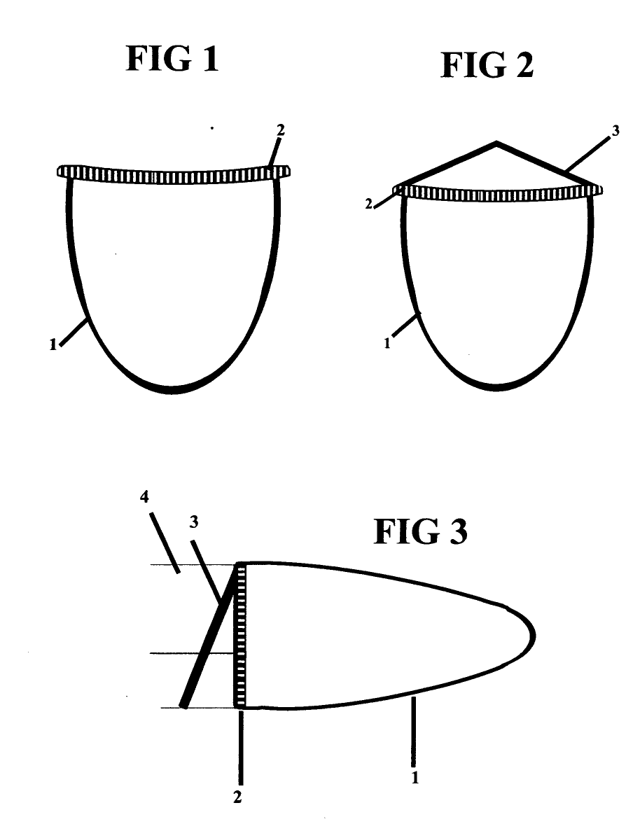

FIG. 1. shows the top view of the tongue sex stimulation device before applying stimulating textures to surface 1. The tongue sex stimulation device may include a ribbed band 2 that is attached to surface 1 and extends around the top of sex stimulation device. The ribbed band 2 will allow the sex stimulation device to fit securely around the tongue and hold in place by virtue of a friction fit.

FIG. 2. shows the bottom view of the tongue sex stimulation device before stimulating textures are applied to surface 1. From this view, the optional reinforcement strap 3 that is attached to the bottom side of ribbed band 2 that is attached to surface of sex stimulation device 1 is shown. The reinforcement strap may add to fit and comfort.

FIG. 3. shows the side view (Left and right identical) of the tongue sex stimulation device without textures on surface 1. The sex stimulation device is shown as the sex stimulation device would look on an actual tongue 4. The ribbed band 2 and reinforcement strap 3 are shown as well as how the reinforcement strap 3 look on the tongue 4.

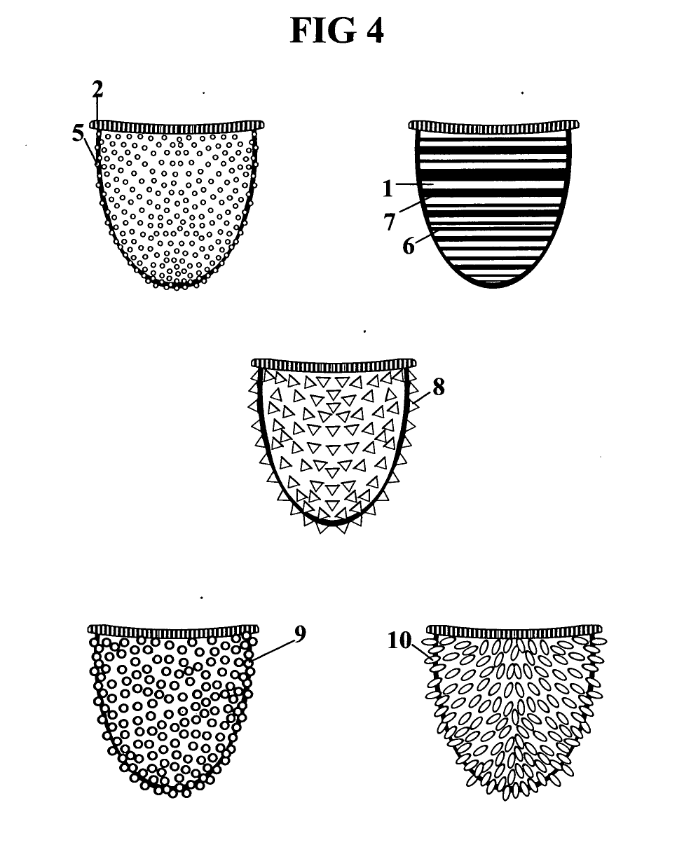

FIG. 4. shows the top of the tongue sex stimulation device with at least five different textures applied to the surface 1. The sex stimulation device is shown as the sex stimulation device would look on an actual tongue 4. The five different texture samples are only one of many. The first texture is small rounded or dome like nodules 5. The second texture are raised horizontal lines or upward extending projections of different thicknesses. The second texture may be the fat raised line or cylinder 6 and the second texture may be the thin raised line or cylinder 7. The third texture is a protruding gummy pointy texture 8. The fourth texture is a large pimple like nodule 9 and finally the fifth texture may be the protruding ovular texture 10.

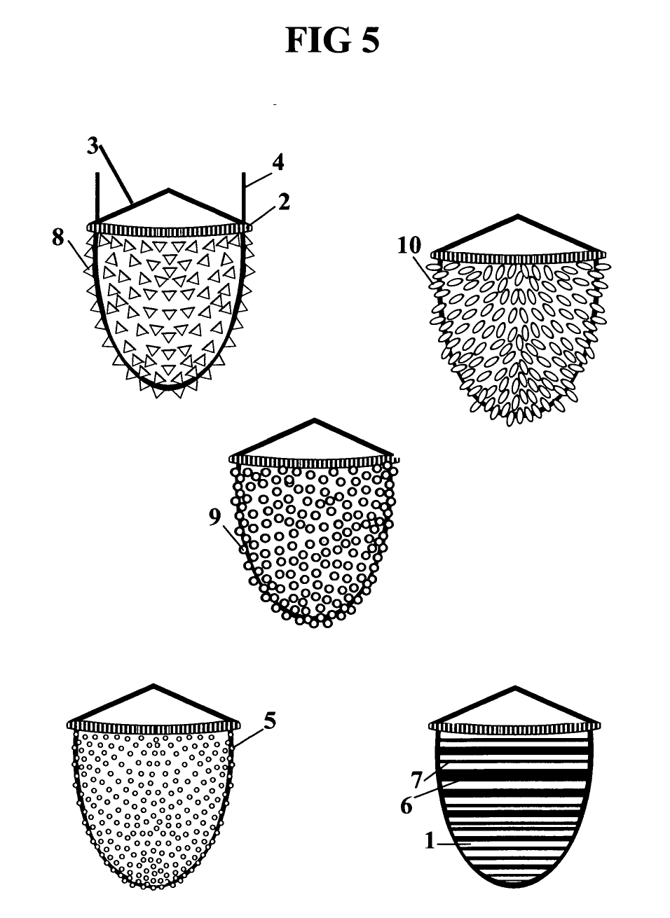

FIG. 5. shows the bottom of the tongue sex stimulation device with at least five different textures applied to the surface 1. FIG. 5 shows how the sex stimulation device would look on an actual tongue 4. Other textures may be employed with the present invention. The first texture may be small pimple/dome like nodules 5. The second texture may be raised horizontal lines/upward extending projections of different thicknesses. 6 being the fat raised line and 7 being the thin raised line. The third texture is a protruding gummy pointy texture 8. The fourth texture is a large pimple/dome like nodule 9 and the fifth texture may be the protruding ovular texture 10.

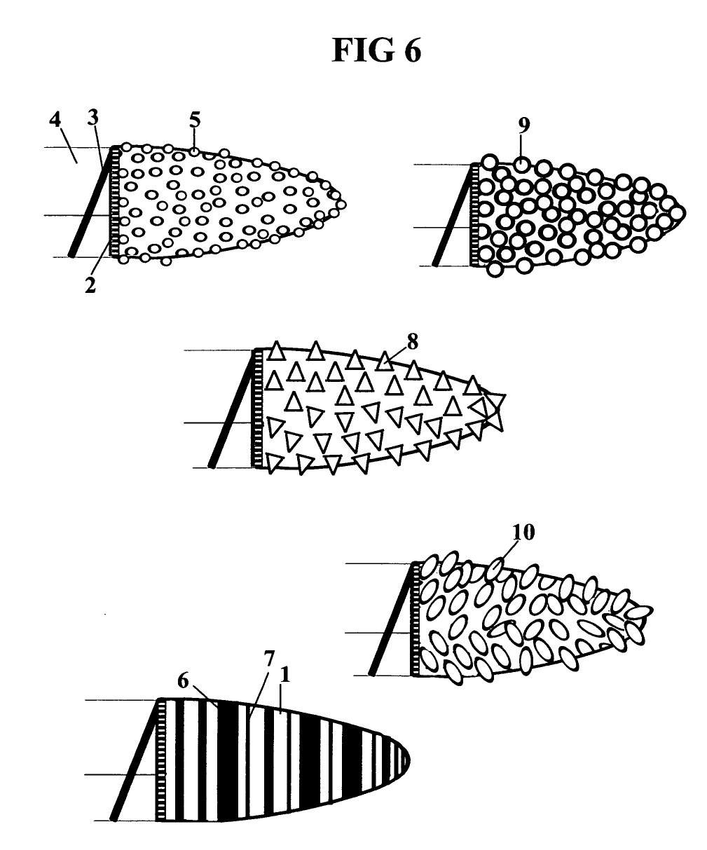

FIG. 6. shows the side of the tongue sex stimulation device with at least five different textures applied to the surface 1. Drawing is shown as it would look on an actual tongue 4. Other textures may be employed with the present invention. The first texture may be small pimple/dome like nodules 5. The second texture may be raised horizontal lines/upward extending projections of different thicknesses. 6 being the fat raised line and 7 being the thin raised line. The third texture is a protruding gummy pointy texture 8. The fourth texture is a large pimple/dome like nodule 9 and the fifth texture may be the protruding ovular texture 10.

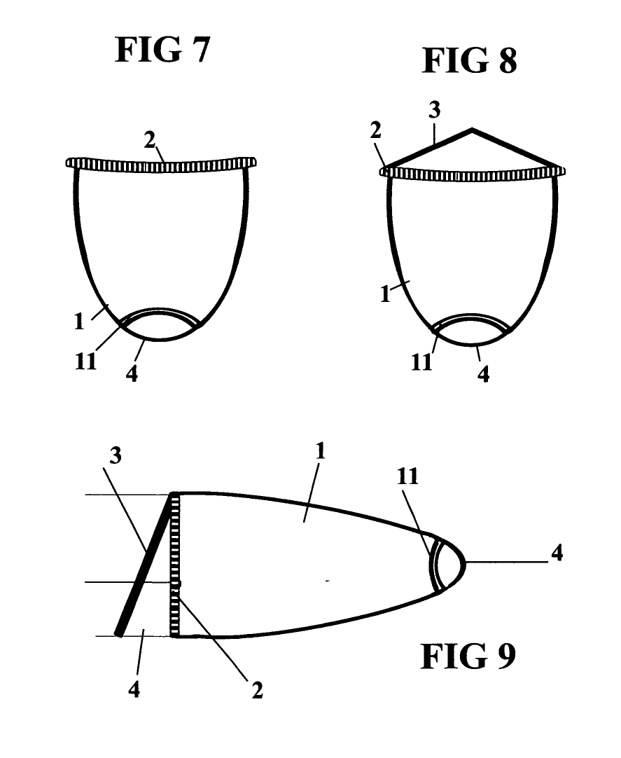

FIGS. 7, 8, and 9. shows the top, bottom and side of the tongue sex stimulation device as shown in FIGS. 1, 2 and 3. with the difference being the truncated tip. The removal of the tip of the tongue sex stimulation device allows the tip of the tongue of the user to be exposed. The removed portion of the tongue sex stimulation device is secured with a ribbed band 11 that wraps around the top of the tongue 4.

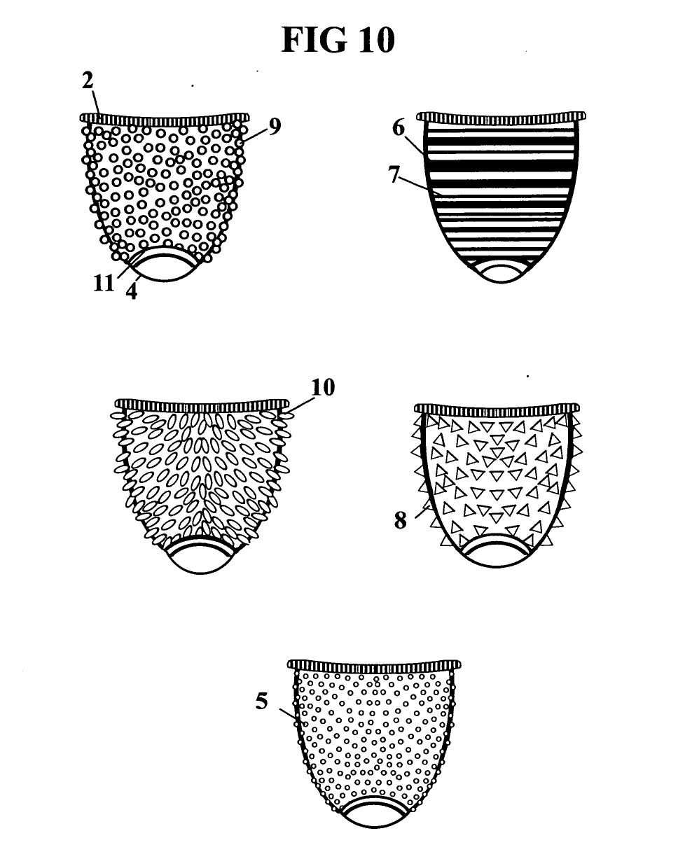

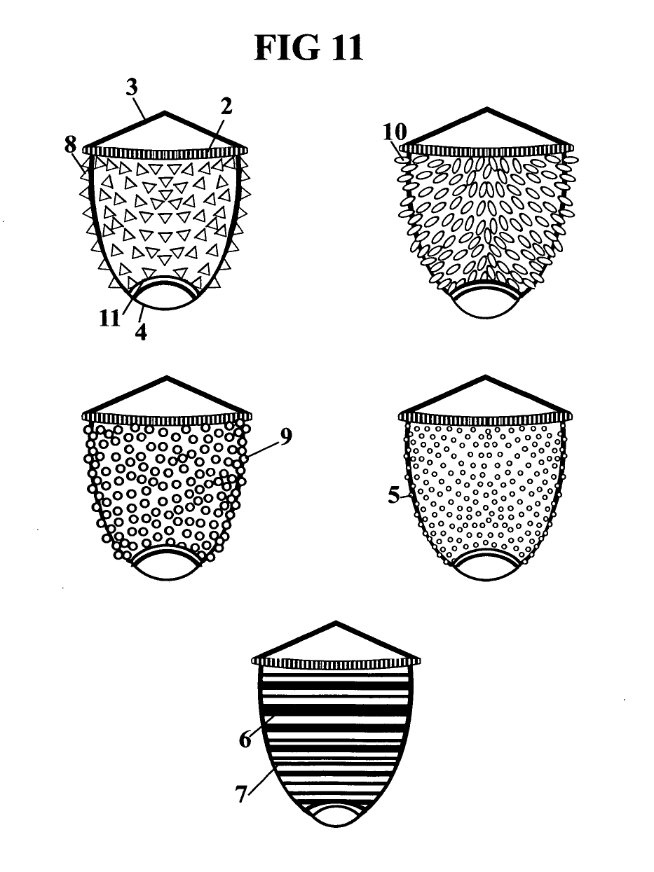

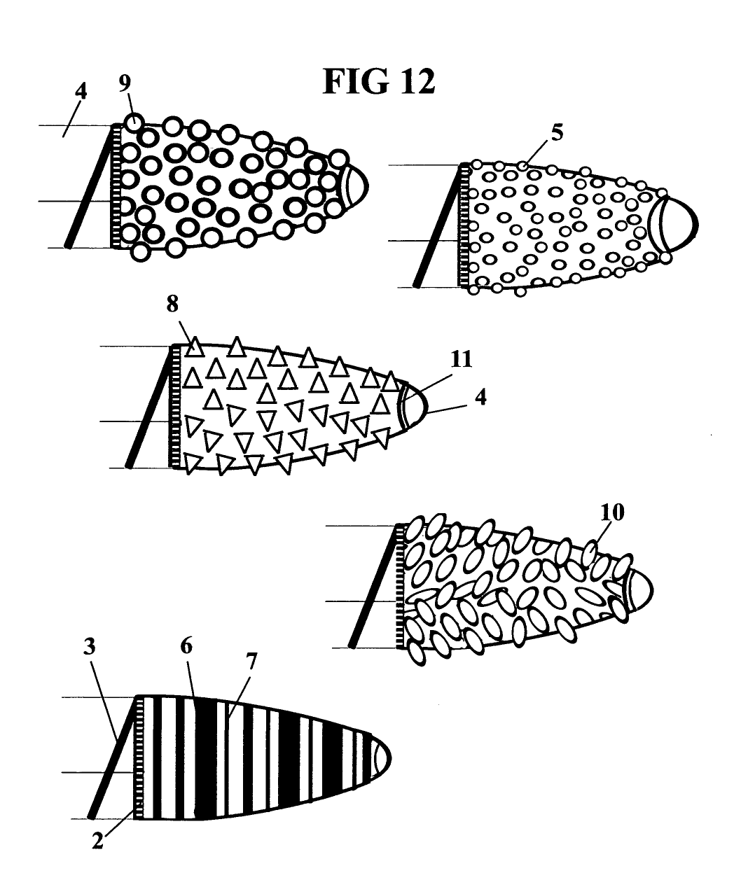

FIGS. 10, 11, and 12. shows the top, bottom and side view of the tongue sex stimulation device as shown in FIGS. 7, 8 and 9 with the same five textures as shown in FIGS. 4, 5 and 6.

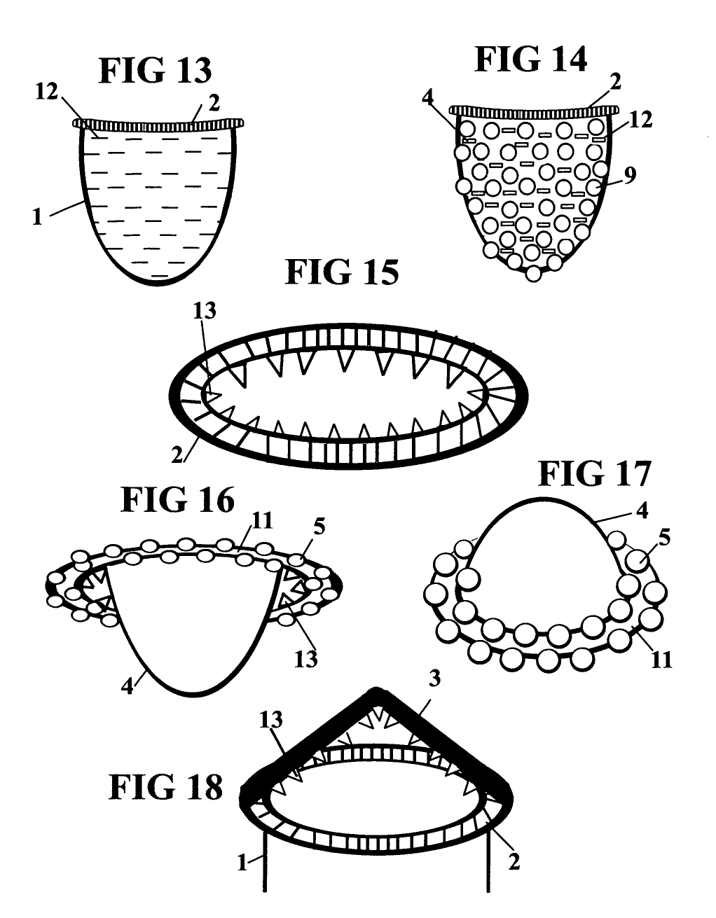

FIG. 13. shows the top of the tongue sex stimulation device similar to the tongue sex stimulation device shown in FIG. 1. FIG. 13 illustrates perforations 12 on the surface 1 of tongue sex stimulation device. The perforations 12 allow the tongues' natural texture of the user to gently come through the openings when stretched onto tongue creating a surface to coincide with the various textures 5, 6, 7, 8, 9 and 10. The sex stimulation device as illustrated in FIG. 13 may be formed with any of the textures 5, 6, 7, 8, 9 and 10. In addition, the sex stimulation device as illustrated in FIG. 13 may be formed with the truncated tip as illustrated in FIGS. 7, 8, 9, 10, 11, and 12.

FIG. 14 shows the top view of the tongue sex stimulation device with the perforations 12 stretched open allowing portions of the tongue 4 to be exposed. FIG. 14 illustrates in addition to the perforations 12, a second texture including the large pimple/dome like nodules texture 9.

FIG. 15 shows an overhead view of the ribbed band 2. FIG. 15 shows small soft teeth 13 that extend around the periphery of the sex stimulation device to provide more grip. The teeth 13 may be combined with the above described textures.

FIG. 16. shows a portion of the sex stimulation device with tongue exposed 4. The ribbed band 11 also features teeth 13 along the inner periphery for a secure grip.

FIG. 17 shows a partial view the sex stimulation device with tongue exposed 4. The ribbed band 11 features tiny pimples/dome 5 for another source of stimulation.

FIG. 18. shows an overhead view of ribbed band 2 and reinforcement strap 3 on surface 1. It also shows teeth 13 on underside of the reinforcement strap 3 for better grip on tongue.

### CONCLUSION

The tongue sex stimulation device will be a stimulator or sexual aid for direct external stimulation. Though the invention is described in detail in and with reference to certain preferred versions thereof, other versions are possible. Therefore, the point and scope of the appended claims should not be limited to the description the preferred versions contained herein.

As to a further discussion of the manner of usage and operation the present invention, the same should be apparent from the above description. According, no further discussion relating to the manner of usage and operation will be provided.

With respect to the above description, it is to be realized that the dimensional relationships for the parts of the invention, to include variations in size, materials, shape, form, function and manner of operation, assembly and use are deemed readily apparent and obvious to one skilled in the art and all equivalent relationships to those illustrated in the drawings and described in the specification are intended to be encompassed by the present invention.

Therefore the foregoing is considered al illustrative only of the principles of the invention Further since numerous modifications and changes will readily occur to skilled in the art, it is not desired to limit the invention to the exact construction and operation shown and described, and accordingly all suitable modifications and equivalents may be resorted to, falling within the scope of the invention.

1. A tongue sex stimulation device for sexual arousal or therapy, comprising:
a flexible housing having at least one texture formed on a surface of the flexible housing,
a ribbed band connected to the flexible housing to secure the flexible housing to the tongue of the user.

2. A tongue sex stimulation device for sexual arousal or therapy as in claim 1, wherein the band comprises a reinforcement strap that is connected to the housing.

3. A tongue sex stimulation device for sexual arousal or therapy as in claim 1, wherein the housing slides onto the tongue with the textures to provide oral stimulation to erogenous zones.

4. A tongue sex stimulation device for sexual arousal or therapy as in claim 1, wherein the sex stimulation device is formed in multiple sizes for tongue size variations.

5. A tongue sex stimulation device for sexual arousal or therapy as in claim 1, where sex stimulation device is formed as a single unit.

6. A tongue sex stimulation device for sexual arousal or therapy as one in claim 1, wherein the housing is formed from at least one of a latex, a lambskin, silicone, elastomeric, or a flavored substance.
While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.
